(19) United States
(12) Patent Application Publication
(10) Pub. No.: US 2026/0343161 A1
(43) Pub. Date: Oct. 29, 2026

(54) GENERATION OF MULTICHANNEL AUDIO SIGNAL

(71) Applicant: KONINKLIJKE PHILIPS N.V., EINDHOVEN (NL)

(72) Inventors: Erik Gosuinus Petrus Schuijers, Breda (NL); Alessio Gallucci, Eindhoven (NL)

(21) Appl. No.: 19/110,213

(22) PCT Filed: Sep. 5, 2023
(86) PCT No.: PCT/EP2023/074221

§ 371 Date: Mar. 10, 2025

(30) Foreign Application Priority Data
Sep. 13, 2022 (EP) 22195259.1

(51) Int. Cl. H04S 3/00; G06N 3/08; H04S 7/00

(52) U.S. Cl. CPC H04S 3/008; G06N 3/08; H04S 7/307; H04S 2400/01

(57) ABSTRACT

An audio apparatus comprises a receiver (101) arranged to receive a data signal comprising downmix audio signal for a multichannel audio signal, upmix parametric data for upmixing the downmix audio signal, and upmix parametric data. A subband generator (103) generates frequency subband signals of the downmix audio signal and a parameter generator (105) generate sets of upmix parameter values. A neural network arrangement (107, 401) comprises a plurality of subband artificial neural networks (107, 401) that receive upmix parameter values as well as samples of at least one frequency subband signal. The subband artificial neural networks (107, 401) generate subband samples for a subband of a frequency subband representation of the multichannel audio signal.

### FIELD OF THE INVENTION

The invention relates to generation of multichannel audio signals and in particular, but not exclusively, to decoding of stereo signals from a downmix monosignal.

### BACKGROUND OF THE INVENTION

Spatial audio applications have become numerous and widespread and increasingly form at least part of many audiovisual experiences. Indeed, new and improved spatial experiences and applications are continuously being developed which results in increased demands on the audio processing and rendering.

For example, in recent years, Virtual Reality (VR) and Augmented Reality (AR) have received increasing interest and a number of implementations and applications are reaching the consumer market. Indeed, equipment is being developed for both rendering the experience as well as for capturing or recording suitable data for such applications. For example, relatively low cost equipment is being developed for allowing gaming consoles to provide a full VR experience. It is expected that this trend will continue and indeed will increase in speed with the market for VR and AR reaching a substantial size within a short time scale. In the audio domain, a prominent field explores the reproduction and synthesis of realistic and natural spatial audio. The ideal aim is to produce natural audio sources such that the user cannot recognize the difference between a synthetic and an original one.

A lot of research and development effort has focused on providing efficient and high quality audio encoding and audio decoding for spatial audio. A frequently used spatial audio representation is multichannel audio representations, including stereo representation, and efficient encoding of such multichannel audio based on downmixing multichannel audio signals to downmix channels with fewer channels have been developed. One of the main advances in low bit-rate audio coding has been the use of parametric multichannel coding where a downmix signal is generated together with parametric data that can be used to upmix the downmix signal to recreate the multichannel audio signal.

In particular, instead of traditional mid-side or intensity coding, in parametric multichannel audio coding a multichannel input signal is downmixed to a lower number of channels (e.g. two to one) and multichannel image (stereo) parameters are extracted. Then the downmix signal is encoded using a more traditional audio coder (e.g. a mono audio encoder). The bitstream of the downmix is multiplexed with the encoded multichannel image parameter bitstream. This bitstream is then transmitted to the decoder, where the process is inverted. First, the downmix audio signal is decoded, after which the multichannel audio signal is reconstructed guided by the encoded multichannel image/upmix parameters.

An example of stereo coding is described in E. Schuijers, W. Oomen, B. den Brinker, J. Breebaart, “Advances in Parametric Coding for High-Quality Audio”, 114th AES Convention, Amsterdam, The Netherlands, 2003, Preprint 5852. In the described approach, the downmixed mono signal is parametrized by exploiting the natural separation of the signal into three components (objects): transients, sinusoids, and noise. In E. Schuijers, J. Breebaart, H. Purnhagen, J. Engdegård, “Low Complexity Parametric Stereo Coding”, 116th AES, Berlin, Germany, 2004, Preprint 6073 more details are provided describing how parametric stereo was realized with a low (decoder) complexity when combining it with Spectral Band Replication (SBR).

In the described approaches, the decoding is based on the use of the so-called de-correlation process. The de-correlation process generates a decorrelated helper signal from the monaural signal. In the stereo reconstruction process, both the monaural signal and the decorrelated helper signal are used to generate the upmixed stereo signal based on the upmix parameters. Specifically, the two signals may be multiplied by a time- and frequency-dependent 2×2 matrix having coefficients determined from the upmix parameters to provide the output stereo signal.

However, although Parametric Stereo (PS) and similar downmix encoding/decoding approaches were a leap forward from traditional stereo and multichannel coding, the approach is not optimal in all scenarios. In particular, known encoding and decoding approaches tend to introduce some distortion, changes, artefacts etc. that may introduce differences between the (original) multichannel audio signal input to the encoder and the multichannel audio signal recreated at the decoder. Typically, the audio quality may be degraded and imperfect recreation of the multichannel occurs. Further, the data rate may still be higher than desired and/or the complexity/resource usage may of the processing may be higher than preferred.

A further issue is the high complexity and computational load at the decoder side, and especially for a given audio quality, it is desirable to reduce complexity and computational load.

Hence, an improved approach would be advantageous. In particular an approach allowing increased flexibility, improved adaptability, an improved performance, increased audio quality, improved audio quality to data rate trade-off, reduced complexity and/or resource usage, reduced computational load, facilitated implementation and/or an improved audio experience would be advantageous.

### SUMMARY OF THE INVENTION

Accordingly, the Invention seeks to preferably mitigate, alleviate or eliminate one or more of the above mentioned disadvantages singly or in any combination.

According to an aspect of the invention, there is provided audio apparatus for generating a multichannel audio signal, the apparatus comprising: a receiver for receiving an audio data signal comprising: a downmix audio signal for the multichannel signal; upmix parametric data for upmixing the downmix audio signal; a subband generator for generating a set of frequency subband signals for subbands of the downmix audio signal; an artificial neural network arrangement comprising a plurality of subband artificial neural networks, each subband artificial neural network of the plurality of subband artificial neural networks being arranged to generate subband samples for a subband of a frequency subband representation of the multichannel audio signal, a parameter generator arranged to generate sets of upmix parameter values for subbands of the frequency subband representation of the multichannel audio signal from the upmix parametric data; a generator for generating the multichannel audio signal from the subbands samples of the subbands of the multichannel audio signal; and wherein each subband artificial neural network comprises a set of nodes arranged to receive a set of upmix parameter values and samples of at least one frequency subband signal of the set of frequency subband signals, the at least one frequency subband signal being for a subband for which the subband artificial neural network generates subband samples of the multichannel audio signal.

The approach may provide an improved audio experience in many embodiments. For many signals and scenarios, the approach may provide improved generation/reconstruction of a multichannel audio signal with an improved perceived audio quality.

The approach may provide a particularly advantageous arrangement which may in many embodiments and scenarios allow a facilitated and/or improved possibility of utilizing artificial neural networks in audio processing, including typically audio encoding and/or decoding. The approach may allow an advantageous employment of artificial neural network(s) in generating a multichannel audio signal from a downmix audio signal.

The approach may provide an efficient implementation and may in many embodiments allow a reduced complexity and/or resource usage. The approach may in many scenarios allow a reduced data rate for data representing a multichannel audio signal using a downmix signal.

The subband samples may span a particular time and frequency range.

The upmix parametric data may comprise parameter (values) relating properties of the downmix signal to properties of the multichannel audio signal. The upmix parametric data may comprise data being indicative of relative properties between channels of the multichannel audio signal. The upmix parametric data may comprise data being indicative of differences in properties between channels of the multichannel audio signal. The upmix parametric data may comprise data being perceptually relevant for the synthesis of the multichannel audio signal. The properties may for example be differences in phase and/or intensity and/or timing and/or correlation. The upmix parametric data may in some embodiments and scenarios represent abstract properties not directly understandable by a human person/expert (but may typically facilitate a better reconstruction/lower data rate etc). The upmix parametric data may comprise data including at least one of interchannel intensity differences, interchannel timing differences, interchannel correlations and/or interchannel phase differences for channels of the multichannel audio signal.

The artificial neural networks are trained artificial neural networks.

The artificial neural networks may be trained artificial neural networks that are trained by training data including training multichannel audio signals; the training employing a cost function comparing the training multichannel audio signals to multichannel signals generated by the artificial neural networks arrangement. The artificial neural networks may be trained artificial neural networks trained by training data including training data representing a range of relevant audio sources including recording of music, videos, movies, telecommunications, etc.

The audio apparatus may specifically be an audio decoder apparatus.

The subband generator may generate one frequency subband signal for each subband of the downmix audio signal. Each frequency subband signal is represented by (subband) samples. Each subband artificial neural network has input nodes that receive (subband) samples of a frequency subband signal generated by the subband generator (and possibly of more than one subband of the downmix audio signal.

Each subband artificial neural network generates an output for a subband of the multichannel audio signal. Each subband artificial neural network specifically generates subband samples representing the multi-channel audio signal in one subband. A subband signal for the subband signal for one subband may be generated by each subband artificial neural network. The subband signal generated for a subband comprises the subband samples generated for that subband by the subband artificial neural network of that subband.

The subbands of the downmix audio signal generated by the subband generator may be the same as the subbands of the multi-channel audio signal as generated by the subband artificial neural networks. However, in some embodiments, they may be different. For example, multiple subbands of the downmix audio signal may be fed to a single subband artificial neural network generating subband samples for a single subband of the multi-channel audio signal.

Each subband artificial neural network may comprise a set of nodes arranged to receive samples for a subband for which the subband artificial neural network generates subband samples for the multichannel audio signal.

In many embodiments, the subbands may have equal bandwidth.

The number of hidden layers in a subband artificial neural network may typically be in the range of 2-100.

The number of input nodes in a subband artificial neural network may typically be in the range of 16 to 1024.

The number of output nodes in a subband artificial neural network may typically be in the range of 1 to 1024.

The number of nodes in hidden layers of a subband artificial neural network may typically be in the range of 64 to 20482.

The number of values in a set of upmix parameters per subband may typically be in the range of 1 to 6.

According to an optional feature of the invention, at least a first subband artificial neural network of the plurality of subband artificial neural networks comprises nodes for receiving parameter values of sets of upmix parameters for other subbands than the subband of the subband artificial neural network.

This may provide a particularly efficient implementation and/or improved performance.

According to an optional feature of the invention, at least some parameters of sets of upmix parameter values for different subband artificial neural networks are the same.

This may provide a particularly efficient implementation and/or improved performance.

According to an optional feature of the invention, at least some parameters of sets of upmix parameter values for different subband artificial neural networks are different.

This may provide a particularly efficient implementation and/or improved performance.

According to an optional feature of the invention, the plurality of subband artificial neural networks for at least one subband comprises separate artificial neural networks for different channels of the multichannel audio signal.

This may provide a particularly efficient implementation and/or improved performance. In particular, separate subband artificial neural networks may be provided for the left and right channel signals of a stereo multichannel audio signal.

According to an optional feature of the invention, the parameter generator is arranged to change a resolution of the sets of upmix parameters relative to a resolution of the upmix parametric data to match a resolution of a processing of the plurality of subband artificial neural networks; the resolution of the processing of the plurality of subband artificial neural networks being one of a frequency resolution of the subbands and a time resolution for a processing time interval for the plurality of subband networks.

In some embodiments, the upmix parametric data may have a different temporal resolution than a processing time interval for at least one subband artificial neural network of the plurality of subband networks; and the parameter generator is arranged to modify the temporal resolution of the sets of upmix parameter values to match the processing time interval for the at least one subband artificial neural network.

In some embodiments, the upmix parametric data may have a different frequency resolution than a frequency resolution of the subbands of the downmix audio signal; and the parameter generator is arranged to modify the frequency resolution of the sets of upmix parameter values to match the frequency resolution of the subbands of the downmix audio signal.

According to an optional feature of the invention, the parameter generator comprises at least one artificial neural network having nodes receiving parameter values of the upmix parametric data and output nodes providing a set of upmix parameter values for a first subband artificial neural network of the plurality of subband artificial neural networks.

This may provide a particularly efficient implementation and/or improved performance.

The at least one artificial neural network may comprise a plurality of subband artificial neural networks. In some embodiments, one or more of the at least one artificial neural network may be common to plurality of subband artificial neural networks generating the samples of the multichannel audio signal.

According to an optional feature of the invention, the plurality of subband artificial neural networks may for at least a first subband comprise at least two subband artificial neural networks generating samples for different components of a subband signal for the first subband.

This may provide a particularly efficient implementation and/or improved performance.

According to an optional feature of the invention, the plurality of subband artificial neural networks is trained by training data having training input audio signals comprising samples of input multichannel audio signals, and using a cost function including a component indicative of a difference between the training input audio signals and multichannel audio signals generated by the subband artificial neural networks.

This may provide a particularly efficient implementation and/or improved performance. It may in many embodiments provide a particularly efficient and high performance training.

According to an optional feature of the invention, the plurality of subband artificial neural networks is trained by training data having training input audio signals comprising samples of input multichannel audio signals, and using a cost function including a component indicative of a difference between upmix parameters for the input audio signals and upmix parameters for the multichannel audio signals generated by the subband artificial neural networks.

This may provide a particularly efficient implementation and/or improved performance. It may in many embodiments provide a particularly efficient and high performance training.

According to an optional feature of the invention, at least one subband artificial neural network of the plurality of subband artificial neural networks comprises: a first sub-artificial neural network having nodes receiving samples of frequency subband signals for the subband of the subband artificial neural network and output nodes providing samples of a modified downmix audio signal; a second sub-artificial neural network having nodes receiving samples of frequency subband signals for the subband of the subband artificial neural network and output nodes providing samples of an auxiliary audio signal; a third sub-artificial neural network having nodes receiving samples of the modified downmix audio signal, nodes receiving samples of an auxiliary audio signal, and nodes receiving a set of upmix parameter values for the subband of the subband artificial neural network, the third sub-artificial neural network further being arranged to generate the subband samples for the subband of the frequency subband representation of the multichannel audio signal.

This may provide a particularly efficient implementation and/or improved performance.

According to an optional feature of the invention, the sets of upmix parameters have a different number of parameters for at least two subbands.

This may provide a particularly efficient implementation and/or improved performance.

According to an optional feature of the invention, the upmix parametric data provides parametric data for sequential time intervals and wherein at least a first subband artificial neural network of the plurality of subband artificial neural networks comprises nodes for receiving parameter values of a set of upmix parameter values for another time interval of the sequential time interval than a time interval for which subband samples of the multichannel audio signal are generated.

This may provide a particularly efficient implementation and/or improved performance.

According to an optional feature of the invention, the plurality of subband artificial neural networks is arranged to receive no other input data than subband samples of the downmix audio signal and parameter values generated from the upmix parametric data.

This may provide a particularly efficient implementation and/or improved performance.

According to an optional feature of the invention, there is provided a method of generating a multichannel audio signal, the method comprising: receiving an audio data signal comprising: a downmix audio signal for the multichannel signal; upmix parametric data for upmixing the downmix audio signal; generating a set of frequency subband signals for subbands of the downmix audio signal; each subband artificial neural network of a plurality of subband artificial neural networks generating subband samples for a subband of a frequency subband representation of the multichannel audio signal, generating sets of upmix parameter values for subbands of the frequency subband representation of the multichannel audio signal from the upmix parametric data; generating the multichannel audio signal from the subbands samples of the subbands of the multichannel audio signal;

and wherein each subband artificial neural network comprises a set of nodes receiving a set of upmix parameter values and samples of at least one frequency subband signal of the set of frequency subband signals, the at least one frequency subband signal being for a subband for which the subband artificial neural network generates subband samples of the multichannel audio signal.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 illustrates some elements of an example of an audio apparatus in accordance with some embodiments of the invention;

FIG. 2 illustrates an example of a structure of an artificial neural network;

FIG. 3 illustrates an example of a node of an artificial neural network;

FIG. 4 illustrates some elements of an example of an audio apparatus in accordance with some embodiments of the invention;

FIG. 5 illustrates some elements of an example of an audio apparatus in accordance with some embodiments of the invention;

FIG. 6 illustrates some elements of an example of an apparatus for training artificial neural networks of an audio apparatus in accordance with some embodiments of the invention; and

FIG. 7 illustrates some elements of a possible arrangement of a processor for implementing elements of an audio apparatus in accordance with some embodiments of the invention.

### DETAILED DESCRIPTION OF SOME EMBODIMENTS OF THE INVENTION

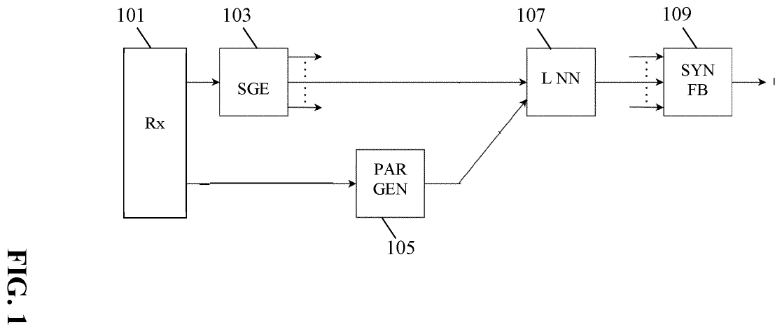

FIG. 1 illustrates some elements of an audio apparatus in accordance with some embodiments of the invention.

The audio apparatus comprises a receiver 101 which is arranged to receive a data signal/bitstream comprising a downmix audio signal which is a downmix of a multichannel audio signal. The following description will focus on a case where the multichannel audio signal is a stereo signal and the downmix signal is a mono signal, but it will be appreciated that the described approach and principles are equally applicable to the multichannel audio signal having more than two channels and to the downmix signal having more than a single channel (albeit fewer channels than the multichannel audio signal).

In addition, the received data signal includes upmix parametric data for upmixing the downmix audio signal. The upmix parametric data may specifically be a set of upmix parameters that indicate relationships between the signals of different audio channels of the multichannel audio signal (specifically the stereo signal) and/or between the downmix signal and audio channels of the multichannel audio signal. Typically, the upmix parameters may be indicative of time differences, phase differences, level/intensity differences and/or a measure of similarity, such as correlation. Typically, the upmix parameters are provided on a per time and per frequency basis (time frequency tiles). For example, new parameters may periodically be provided for a set of subbands. Parameters may specifically include Inter-channel phase difference (IPD), Overall phase difference (OPD), Inter-channel correlation (ICC), Channel phase difference (CPD) parameters as known from Parametric Stereo encoding (as well as from higher channel encodings).

Typically, the downmix audio signal is encoded and the receiver 101 includes a decoder that decodes the downmix audio signal, i.e. the mono signal in the specific example. It will be appreciated that the decoder may not be needed in case the received downmix audio signal is not encoded and that the decoder may be considered to be an integral part of the receiver. Similarly, the receiver 101 may comprising functionality for extracting and decoding data representing the upmix parameters.

Traditionally, decoding of signals such as PS encoded stereo signals are based on generating a decorrelated signal from the downmix audio signal (specifically the monosignal) and then applying a (time- and frequency-dependent) 2×2 matrix multiplication to the samples of the downmix audio signal and the decorrelated signal resulting in the output multichannel audio signal. The coefficients of the 2×2 matrix are determined from the upmix parameters of the upmix parametric data. However, whereas such an approach may be suitable for many applications, it is not ideal in all circumstances and tends to have suboptimal performance in some scenarios. The approach of FIG. 1 uses a fundamentally different approach which may provide improved performance and/or facilitated implementation in many embodiments and scenarios.

In the approach of FIG. 1, the receiver 101 is coupled to a subband generator 103 which is arranged to generate a plurality of frequency subband signals for subbands of the downmix audio signal. Thus, a subband representation of the downmix audio signal is generated with the subband generator 103 generating subband samples for different frequency subbands, and thus it generates a plurality of subband samples for different subbands.

Specifically, the subband generator 103 may include a filter bank which is arranged to generate the frequency subband representation of the downmix audio signal. The filter bank may be Quadrature Mirror Filter (QMF) bank or may e.g. be implemented by a Fast Fourier Transform (FFT), but it will be appreciated that many other filter banks and approaches for dividing an audio signal into a plurality of subband signals are known and may be used. The filter-bank may specifically be a complex-valued pseudo QMF bank, resulting in e.g. 32 or 64 complex-valued sub-band signals.

In many embodiments, the filterbank 501 is arranged to generate a set of subband signals for subbands having equal bandwidth. In other embodiments, the filterbank 401 may be arranged to generate subband signals with subbands having different bandwidths. For example, a higher frequency subbands may have a higher bandwidth than a lower frequency subband. Also, subbands may be grouped together to form a higher bandwidth sub-band.

Typically, the subbands may have a bandwidth in the range from 10 Hz to 10000 Hz.

The audio apparatus further comprises a parameter generator 105 arranged to generate sets of upmix parameters for the subbands of the downmix audio signal from the received upmix parametric data. In some embodiments, the parameter generator 105 may simply forward received upmix parameters without modification but may select and distribute appropriate upmix parameters to other functional units. In other embodiments, it may process the received upmix parameter values to generate new parameter values, e.g. by interpolation and/or upsampling.

The audio apparatus further comprises an artificial neural network arrangement comprising a plurality of subband artificial neural networks 107 of which, for clarity, only one is shown in FIG. 1. In many embodiments, the artificial neural network arrangement may include one subband artificial neural network 107 for each subband generated by the subband generator 103. Each of the subband artificial neural networks 107 is arranged to generate subband samples for a subband of a frequency subband representation of the multichannel audio signal. Each subband artificial neural network 107 comprises a set of output nodes that generate samples for a subband of the multichannel audio signal being reconstructed. The subband artificial neural networks 107 have nodes arranged to receive subband samples of the downmix audio signal, and specifically subband samples of one or more subbands that correspond to the frequencies of the subband of the multichannel audio signal for which the subband artificial neural network 107 is generating output samples is provided to input nodes of that subband artificial neural network 107. In addition, the subband artificial neural network 107 includes nodes that receive a set of upmix parameter values for the subband from the parameter generator 105. In many embodiments, the individual subband artificial neural network 107 may receive a set of upmix parameters which are the upmix parameters that are received in the upmix parametric data, and which are provided for the subband of the specific subband artificial neural network 107.

In many embodiments, the subbands generated by the subband generator 103 and the subbands for which the subband artificial neural networks 107 generate samples may be the same. There may be a direct correspondence between subbands of the downmix audio signal and subbands of the multichannel audio signal. In particular, there may be one subband artificial neural network 107 for each subband generated by the subband generator 103 and each of these may generate subband samples of the multichannel audio signal for the same subband. In some embodiments, some subbands of the downmix audio signal may for example be combined to be processed by the same subband artificial neural network 107 (which can be considered equivalent to one subband having the combined bandwidth of the subbands that are combined). The subband artificial neural network 107 may in this case generate subband samples for the combined subband.

As will be described in more detail later, the subband artificial neural networks 107 are trained to generate subbands samples that reconstruct a multichannel audio signal from downmix audio signals and upmix parameters. In the approach, a downmix audio signal is accordingly divided into subbands which are processed by trained subband artificial neural networks 107 directly generating subband samples of the multichannel audio signal.

The subband artificial neural networks 107 are coupled to a signal generator 109 which generates the multichannel audio signal from the subbands samples of the subbands of the multichannel audio signal.

The subband samples from the subband artificial neural networks are fed to the signal generator 109 which proceeds to generate the reconstructed multichannel audio signal. For example, in some embodiments where a subband representation of the multichannel audio signal is desired (e.g. due to a subsequent processing also being subband based), the signal generator 109 may simply output the subband samples from the subband artificial neural networks, possibly in accordance with a specific structure or format. In many embodiments, the signal generator 109 comprises functionality for converting the subband representation of the reconstructed multichannel audio signal to a time domain representation. The signal generator 109 may specifically comprise a synthesis filterbank performing the inverse operation of the subband generator 103, and specifically of a filterbank of the subband generator 103, thereby converting the subband representation to a time domain representation of the multichannel audio signal.

The generator may specifically be arranged to generate a frequency/subband-domain representation of the multichannel audio signal by processing the frequency or subband-domain representation of the downmix audio signal and the frequency/subband-domain representation of the auxiliary audio signal. The processing of the generator 105 may thus be a subband processing, such as for example a matrix multiplication performed in each subband on the subband samples of the downmix audio signal and the auxiliary audio signal generated by the corresponding subband artificial neural network.

The resulting subband/frequency domain representation may then be used directly or may e.g. be converted to a time domain representation using a suitable synthesis filter bank, which in particular may be applied by separate synthesis filters for each channel.

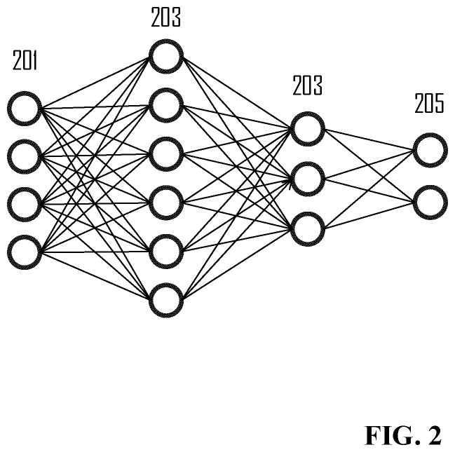

An artificial neural network as used in the described functions may be a network of nodes arranged in layers and with each node holding a node value. FIG. 2 illustrates an example of a section of an artificial neural network.

The node value for a given node may be calculated to include contributions from some or often all nodes of a previous layer of the artificial neural network. Specifically, the node value for a node may be calculated as a weighted summation of the node values of all the nodes output of the previous layer. Typically, a bias may be added and the result may be subjected to an activation function. The activation function provides an essential part of each neuron by typically providing a non-linearity. Such non-linearities and activation functions provides a significant effect in the learning and adaptation process of the neural network. Thus, the node value is generated as a function of the node values of the previous layer.

The artificial neural network may specifically comprise an input layer 201 comprising a plurality of nodes receiving the input data values for the artificial neural network. Thus, the node values for nodes of the input layer may typically directly be the input data values to the artificial neural network and thus may not be calculated from other node values.

The artificial neural network may further comprise none, one, or more hidden layers 203 or processing layers. For each of such layers, the node values are typically generated as a function of the node values of the nodes of the previous layer, and specifically a weighted combination and added bias followed by an activation function may be applied.

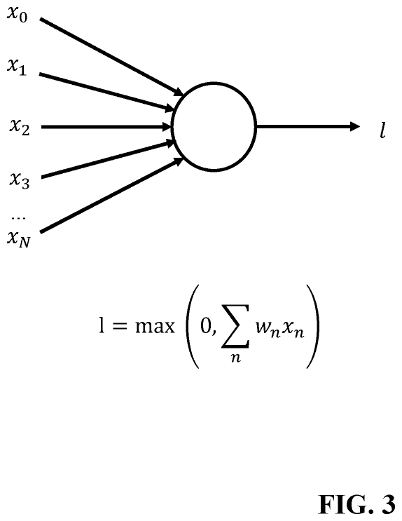

Specifically, as shown in FIG. 3, each node, which may also be referred to as a neuron, may receive input values (from nodes of a previous layer) and therefrom calculate a node value as a function of these values. Often, this includes first generating a value as a linear combination of the input values with each of these weighted by a weight:

$$k = {\sum }_{n} {w}_{{n}^{x} n}$$

where w refers to weights, x refers to the nodes of the previous layer and n is an index referring to the different nodes of the previous layer.

An activation function may then by applied to the resulting combination. For example, the node value 1 may be determined as:

l=ƒ(k)

where the function may for example be a sigmoid, Tanh or Rectified Linear Unit (ReLU) function (as described in Xavier Glorot, Antoine Bordes, Yoshua Bengio Proceedings of the Fourteenth International Conference on Artificial Intelligence and Statistics, PMLR 15:315-323, 2011.:

ƒ(k)=ReLU(k)=max(0,k)

Other often used functions include a sigmoid function or a tanh function. In many embodiments, the node output or value may be calculated using a plurality of functions. For example, both a ReLU and Sigmoid function may be combined using an activation function such as:

ƒ(k)=ReLU(k)+σ(k)

Such operations may be performed by each node of the artificial neural network (except for typically the input nodes).

The artificial neural network further comprises an output layer 205 which provides the output from the artificial neural network, i.e. the output data of the artificial neural network is the node values of the output layer. As for the hidden/processing layers, the output node values are generated by a function of the node values of the previous layer. However, in contrast to the hidden/processing layers where the node values are typically not accessible or used further, the node values of the output layer are accessible and provide the result of the operation of the artificial neural network.

A number of different networks structures and toolboxes for artificial neural network have been developed and in many embodiments the artificial neural network may be based on adapting and customizing such a network. An example of a network architecture that may be suitable for the applications mentioned above is WaveNet by van den Oord et al which is described in Oord, Aaron van den, Sander Dieleman, Heiga Zen, Karen Simonyan, Oriol Vinyals, Alex Graves, Nal Kalchbrenner, Andrew Senior, and Koray Kavukcuoglu. “Wavenet: A generative model for raw audio.” arXiv preprint arXiv: 1609.03499 (2016).

WaveNet is an architecture used for the synthesis of time domain signals using dilated causal convolution, and has been successfully applied to audio signals. For WaveNet the following activation function is commonly used:

z=tan h(W_{ƒ,k}*x)⊙σ(W_{g,k}*x),

where * denotes a convolution operator, ⊙ denotes an element-wise multiplication operator, σ(·) is a sigmoid function, k is the layer index, f and g denote filter and gate, respectively, and W represents the weights of the learned artificial neural network. The filter product of the equation may typically provide a filtering effect with the gating product providing a weighting of the result which may in many cases effectively allow the contribution of the node to be reduced to substantially zero (i.e. it may allow or “cut-off” the node providing a contribution to other nodes thereby providing a “gate” function). In different circumstances, the gate function may result in the output of that node being negligible, whereas in other cases it would contribute substantially to the output. Such a function may substantially assist in allowing the neural network to effectively learn and be trained.

An artificial neural network may in some cases further be arranged to include additional contributions that allow the artificial neural network to be dynamically adapted or customized for a specific desired property or characteristics of the generated output. For example, a set of values may be provided to adapt the artificial neural network. For example, a set of values may be provided to adapt the artificial neural network. These values may be included by providing a contribution to some nodes of the artificial neural network. These nodes may be specifically input nodes but may typically be nodes of a hidden or processing layer. Such adaptation values may for example be weighted and added as a contribution to the weighted summation/correlation value for a given node. For example, for WaveNet such adaptation values may be included in the activation function. For example, the output of the activation function may be given as:

z=tan h(W_{ƒ,k}*x+V_{ƒ,k}*y)⊙σ(W_{g,k}*x+V_{g,k}*y)

where y is a vector representing the adaptation values and V represents suitable weights for these values.

The above description relates to a neural network approach that may be suitable for many embodiments and implementations. However, it will be appreciated that many other types and structures of neural network may be used. Indeed, many different approaches for generating a neural network have been, and are being, developed including neural networks using complex structures and processes that differ from the ones described above. The approach is not limited to any specific neural network approach and any suitable approach may be used without detracting from the invention.

In the audio apparatus of FIG. 1, a single subband artificial neural network 107 is used for generating subband samples of multiple channels of the multichannel audio signal in a given subband, and specifically a single subband artificial neural network 107 was used for generating subband samples for both channels of a stereo signal. Thus, the subband artificial neural network 107 may generate output samples for both the left and right channels.

However, in many embodiments, separate subband artificial neural networks 107 may be provided for the individual channels of the multichannel audio signal and thus parallel structures and arrangements of subband artificial neural networks 107 may be provided for the individual channels.

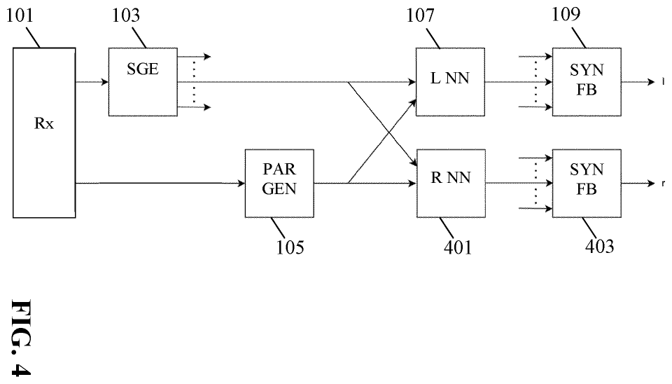

FIG. 4 illustrates an example of an audio apparatus corresponding to that of FIG. 1 but with separate subband artificial neural networks 107, 401 for respectively the left and right channel. In the example, the subband artificial neural networks 107 are arranged and trained to generate samples of the left signal of the stereo signal. In addition, a second subband artificial neural network 401 is arranged and trained to generate samples of the right signal of the stereo signal. Both the first and second subband artificial neural networks 107, 401 have input nodes receiving the subband samples from the subband generator 103. Similarly, both the first and second subband artificial neural networks 107, 401 receive upmix parameters from the parameter generator 105 but in some embodiments, they may receive different upmix parameters. For example, one or more upmix parameters may specifically be indicative of a property of one channel signal relative to the downmix audio signal and such a parameter may specifically be provided to only the subband artificial neural network 107, 401 for the channel to which the upmix parameter is related.

In such embodiments, an individual signal generator may be provided and applied to the individual subband artificial neural networks 107, 401. In particular, the signal generator 109 may receive the output samples form the first subband artificial neural network 107 and a second and separate signal generator 403 may receive the subband samples from the second subband artificial neural network 401.

In the approach, the left and right channels of the multichannel audio signal are obtained directly from two pre-trained artificial neural networks taking the downmix signal as well as the decoded upmix parameters as input. The approach is performed on a subband basis such that individual artificial neural networks are provided for different subbands and with the multichannel audio signal reconstruction and synthesis being achieved by a combination of a plurality of subband artificial neural networks that interwork to provide a direct generation of the multichannel audio signal. The artificial neural network arrangement does not require or include any decorrelation signal or rotation/matrix multiplication to be performed (although the artificial neural network may in some cases potentially result in operations that may correspond to more extensive (and less obviously dissectible) variants of such operations). The approach has been found to provide a substantially improved reconstruction of the multichannel audio signal in many scenarios and embodiments. Further, it may facilitate implementation and may often reduce the computational burden. For example, using a subband approach may often reduce complexity and resource usage as the individual subband artificial neural networks may typically be substantially smaller than if e.g. a single artificial neural network needed to generate samples for all frequencies of the multichannel audio signal. Although, more artificial neural networks may be used for the subband processing, the size reduction that can be achieved is often much larger than a simple linear scaling and thus an overall complexity reduction requiring substantially fewer calculations and operations can be achieved.

The subband artificial neural networks 107 may specifically receive subband samples of the downmix audio signal as well as parameter values determined from the subband generator 103 from the received upmix parametric data but may typically be provided with no other input data. Thus, the approach does not require any additional information, operation, or data except for that of the encoded signal representing the multichannel audio signal, and specifically does not require any data except for subband samples and upmix parameters.

In the arrangement, each of the subband artificial neural networks receives subband samples for the subband of the subband artificial neural network and further all of the subband artificial neural networks are arranged to receive a set of upmix parameter values.

Each of the subband artificial neural networks generates subband samples for a subset of subbands of a frequency subband representation of the multichannel audio signal, and typically generates (only) subband samples for the subband for which it receives input samples from the subband generator 103.

In many embodiments, the apparatus includes an artificial neural network for each subband of the frequency subband representation of the downmix audio signal generated by the subband generator 103. Thus, in many embodiments, the output samples for each subband of the subband generator 103 is fed to input nodes of one subband artificial neural network with that subband artificial neural network then generating subband samples of the multichannel audio signal for that subband. In many embodiments, the subband processing may thus be completely separate for each subband.

In the example, the generation of the multichannel audio signal is thus performed on a subband by subband basis with separate and individual artificial neural networks in each subband. The individual artificial neural networks are trained to provide output samples for the subband for which they are provided input subband samples.

Such an approach has been found to provide a very advantageous generation of a multichannel audio signal that allows a very high quality reconstruction of the multichannel audio signal. Further, it may allow a highly efficient operation with substantially reduced complexity and/or typically substantially reduced computational resource requirements. The subband artificial neural networks tend to be substantially smaller than a single full artificial neural network required for generation of the entire signal. Typically, a lot fewer nodes, and possibly even fewer layers, are required for the processing resulting in a very big reduction in the number of operations and calculations required to implement the artificial neural network functionality. Although more artificial neural networks are needed to cover all the subbands, the smaller artificial neural networks will typically result in a huge reduction in the overall number of operations required, and thus in the overall computational resource requirement. Further, in many scenarios it may allow a more efficient learning process.

The subband arrangement may accordingly provide a computationally efficient approach for allowing artificial neural networks to be implemented to assist in the reconstruction of a multichannel audio signal which has been encoded as a downmix audio signal with upmix parametric data. The described system and approach allow a high quality multichannel audio signal to be reconstructed and typically significantly improved audio quality can be achieved compared to a conventional approach. Further, a computationally efficient decoding process can be achieved. The subband and artificial neural network based approach may further be compatible with other processing using subband processing.

In some embodiments, the subband processing may be more flexible than a strict subband by subband processing. For example, in some embodiments, each subband artificial neural network may receive subband samples from not only the subband itself but possibly also for one or more other subbands. For example, the subband artificial neural network for one subband may in some embodiments also receive samples of the downmix audio signal from one or two neighbor/adjacent subbands. As another example, in some embodiments, one or more of the subband artificial neural networks may also receive input samples from one or more subbands comprising harmonics (or subharmonics) for frequencies of the subband. For example, a subband around a 500 Hz center frequency may also receive frequencies from a subband around a 1000 Hz center frequency. Such additional subbands having a specific relationship to the subband of the subband artificial neural network may provide additional information that may allow an improved subband artificial neural network to be generated for some audio signals.

In some embodiments, all the subband artificial neural networks may have the same properties and dimensions. In particular, in many embodiments, all the subband artificial neural networks may have the same number of input nodes and output nodes, as well as possibly the same internal structure. Such an approach may for example be used in embodiments where all subbands have the same bandwidth.

In some embodiments, the subband artificial neural networks may however include non-identical neural networks. In particular, in some embodiments, the number of input nodes for the subband artificial neural networks may be different for at least two of the artificial neural networks. Thus, in some embodiments, the number of input samples being included in the determination of the output samples may be different for different subbands and subband artificial neural networks.

In some embodiments, the number of samples/input nodes may be higher for some lower frequency subbands than for some higher frequency bands. Indeed, the number of samples/input nodes may be monotonically decreasing for increasing frequency. The lower frequency subband artificial neural networks may thus be larger and consider more input samples than higher frequency subband artificial neural networks. Such an approach may for example be combined with subbands having different bandwidths, such as when lower frequency subbands may have a higher bandwidth than higher frequency bandwidths.

Such an approach may in many scenarios provide an improved trade-off between the audio quality that can be achieved and the computational complexity and resource usage. It may provide a closer adaptation of the system to reflect typical characteristics of audio thereby allowing a more efficient processing.

In some embodiments, subband artificial neural networks may only be employed for a subset of subbands of the downmix audio signal and/or the multichannel audio signal. For other subbands, other approaches may be applied, and specifically for one or more subbands, a conventional approach of generating a decorrelated signal that is mixed with the mono downmix audio signal to generate a stereo signal may be applied. Thus, the described subband artificial neural network approach may only be applied for some subbands.

In some embodiments, the number of hidden layers may be higher for some lower frequency bands than for some higher frequency bands. The number of hidden layers may be monotonically decreasing for increasing frequency. Such an approach may in many scenarios provide an improved trade-off between the audio quality that can be achieved and the computational complexity and resource usage.

In some embodiments, at least some of the set of upmix parameter values are common for a plurality of subbands of the frequency subband representation of the downmix audio signal.

In some embodiments, the subband artificial neural networks are all provided with the same set of upmix parameter values. In some embodiments, only some of the subband artificial neural networks may be provided with the same set of upmix parameter values. Specifically, in some embodiments at least one control data value of the of control data values is processed by at least two synthesis subband artificial neural networks.

Using the same set of upmix parameter values may in many embodiments provide improved efficiency and performance. It may often reduce complexity and resource usage in generating the set of upmix parameter values. Further, in many scenarios it may provide improved operation and that all the available information provided by the parameter values may be considered by each subband artificial neural network, and thus improved adaptation of the subband artificial neural networks may be achieved.

However, in many embodiments, different subband artificial neural networks may be provided with different sets of upmix parameter values. In particular, in some embodiments, at least one parameter value of the sets of upmix parameter values is not processed by at least one subband artificial neural networks.

For example, the parameter generator 105 may generate a set of upmix parameter values and different subsets of these may be provided to different subband artificial neural networks. In other embodiments, some parameter sets may also be generated to include some parameter values that are e.g. provided manually or generated by an analysis of the downmix audio signal. For example, harmonics or peaks may be detected in the downmix audio signal. Such data may e.g. only be applied to some of the synthesis subband artificial neural networks. For example, detected peaks or harmonics may only be indicated to the synthesis subband artificial neural networks of the subbands in which they are detected. In some embodiments, such properties and features may be generated at the encoder side and provided to the audio apparatus as part of the data signal. Such received features may also be provided to the artificial neural networks, i.e. subband artificial neural networks may include input nodes for receiving values representing such properties.

In some embodiments, the encoder may alternatively or additionally generate upmix parametric data in the form of data representing or describing e.g. properties of the downmix audio signal, e.g. in relation to properties of one or more channels of the multichannel audio signal. Indeed, in some embodiments, the encoder may comprise an artificial neural network that generates a set of parameter values that for a downmix audio signal provides a latent representation which is particularly suitable for upmixing the downmix audio signal to reconstruct the multichannel audio signal with the upmixing being performed by an artificial neural network arrangement as described herein. In such cases, the encoder artificial neural network generating the latent representation/parameter values may be jointly trained with the subband artificial neural networks 107.

In many embodiments, different subband artificial neural networks may thus be provided with different sets of upmix parameter values. In many cases, this may include some parameter values being the same and some parameter values being different for different subband artificial neural networks.

As mentioned, the parameter generator 105 may in some embodiments generate the sets of upmix parameters for the different subband artificial neural networks 107 by selecting appropriate parameters from the received upmix parametric data and providing these directly to the appropriate subband artificial neural network 107.

For example, in many embodiments, the upmix parametric data comprises upmix parameters that are frequency and time dependent. For example, IPD, OPD, ICC, CPD parameters may be provided for distinct time-frequency tiles. In such cases, the upmix parameters provided in the upmix parametric data for the frequency subband of one subband artificial neural network 107 for a given time interval may be compiled into a set of upmix parameters that are then fed to the subband artificial neural network 107 when processing the given time interval. Thus, when a given subband artificial neural network 107 is generating subband samples for a given time interval, the parameter generator 105 may generate a set of upmix parameters comprising upmix parameters that are provided for that time interval and for that subband. In addition, the subband artificial neural network 107 will receive subband samples of the downmix audio signal thereby enabling it to process this input data to generate the subband samples for the reconstructed multichannel audio signal.

In some embodiments, each set of upmix parameters may include parameter values only for the subband for which the subband artificial neural network 107 generates samples, and thus only parameter values for the subband of the individual subband artificial neural network 107 is only provided to that subband artificial neural network 107. However, in some embodiments, the set of upmix parameters for one subband artificial neural network 107 may include parameter values for other subbands than the subband for which the subband artificial neural network 107 generates samples. Thus, in some embodiments, the subband artificial neural network 107 may comprise nodes for receiving parameter values for other subbands than the subband of the subband artificial neural network.

In some embodiments, the parameter generator 105 may generate a set of upmix parameter values for a given subband based on received upmix parametric data for that subband. However, one or more of the subband artificial neural networks may in addition to the set generated for the subband of the subband artificial neural network also include parameter values for one or more other subbands, i.e. the input to the subband artificial neural network may have an input node that receives a subband sample for a subband for which the subband artificial neural network does not generate any samples.

As a specific example, in many embodiments, each subband artificial neural network may as input receive parameter values from not only the subband for which it generates a set of samples but also from say the neighboring subbands.

Such approaches may often allow an improved set of upmix parameter values to be generated which may lead to improved audio quality. In particular, it has been found that considering surrounding subbands may allow the set of upmix parameter values to better reflect temporal resolution of the downmix audio signal/multichannel audio signal. It has been found that such an approach may in particular allow a better representation of temporal peakedness.

In some embodiments, one or more of the subband artificial neural networks may also be fed subband samples from outside the time interval for which the subband artificial neural network generates samples of the multichannel audio signal. The subband artificial neural network(s) may include input nodes that receive subband samples from outside the current time interval.

In particular, the processing of the audio apparatus may be performed on a frame by frame basis where a time interval/frame of the received downmix audio signal is processed to generate output samples for the multichannel audio signal for that time interval/frame. Thus, for each frame, the subband generator 103 generates subband samples, the parameter generator 105 generates parameter values for that frame, and the subband samples and parameter values are fed to the subband artificial neural networks which generates the subband samples for the multichannel audio signal for that frame/time interval of the multichannel audio signal.

Thus, in particular, each subband artificial neural network operates in block form with each operation where a set of output samples are generated from a set of input samples corresponding to a time interval of the downmix audio signal/multichannel audio signal for which output samples of the multichannel audio signal are generated.

In some embodiments, one or more of the subband artificial neural networks may in addition to the parameter values that are given for that subband also receive parameter values for another time interval, such as typically from one or more neighbor time intervals. For example, in some embodiments, one or more of the subband artificial neural networks may also include the parameter values for the previous and next time interval.

In such examples, the upmix parametric data accordingly provides parameters for a plurality of different sequential time intervals. For a given time interval, the subband artificial neural networks 107 are provided with parameter values for the time interval of the multichannel audio signal for which the subband samples are generated. However, in addition, in some embodiments, one or more of the subband artificial neural networks 107 also comprises nodes for receiving parameter values for other time intervals of the sequential time interval than the time interval for which subband samples of the multichannel audio signal are (currently) generated.

In some embodiments, the subband samples provided to a subband artificial neural network 107 may be only for the subband for which the subband artificial neural network 107 generates samples, and thus subband samples for the subband of the individual subband artificial neural network 107 is only provided to that subband artificial neural network 107. However, in some embodiments, the subband samples for one subband artificial neural network 107 may include subband samples for other subbands than the subband for which the subband artificial neural network 107 generates samples. Thus, in some embodiments, the subband artificial neural network 107 may comprise nodes for receiving subband samples for other subbands than the subband of the subband artificial neural network.

As a specific example, in many embodiments, each subband artificial neural network may as input receive subband samples from not only the subband for which it generates a set of upmix parameter values but also from say the neighboring subbands.

Such approaches may often lead to improved audio quality. In particular, it has been found that considering surrounding subbands may allow the generated subband samples to better reflect temporal resolution of the downmix audio signal/multichannel audio signal. It has been found that such an approach may in particular allow a better representation of temporal peakedness.

Each subband artificial neural network may operate in processing time intervals with each operation where a set of output samples are generated from a set of input samples correspond to a time interval of the downmix audio signal/multichannel audio signal for which output samples of the multichannel audio signal are generated.

In some embodiments, one or more of the subband artificial neural networks may in addition to the subband samples that are given for that time interval also receive subband samples for another time interval, such as typically from one or more neighbor time intervals. For example, in some embodiments, one or more of the subband artificial neural networks may also include the subband samples for the previous and next time interval.

Typically, upmix parameters received in the upmix parametric data will have a time- and frequency resolution that is different from subband domain downmix audio signal and the subbands and processing time intervals of the subband artificial neural networks 107. In many embodiments, the parameter generator 105 may be arranged to adapt the received upmix parameters to generate sets of upmix parameter values that match the time- and frequency resolution of the processing of the subband artificial neural networks 107.

In many embodiments, the parameter generator 105 is accordingly arranged to change a resolution of the sets of upmix parameters relative to a resolution of the upmix parametric data to match a resolution of a processing of the plurality of subband artificial neural networks 107. The change in resolution may be in the frequency and/or time domain, and may be performed to align the upmix parametric data to the frequency resolution of the subbands and/or a time resolution for a processing time interval for the plurality of subband networks.

In some embodiments, the change in resolution may effectively be a resampling of the received parameter values to match the time and frequency resolution of the subband processing. For example, in some embodiments, a linear interpolation may be applied to each parameter to generate sample values of the parameter for time and frequency intervals corresponding to the subband processing. For example, if the upmix parametric data comprises parameter values for two frequencies corresponding to two adjacent subbands that are larger than the subbands of the subband processing, parameter values for the processing subbands may be found by simple interpolation between the parameter values comprised in the upmix parametric data. Similarly, if the parameter values of the upmix parametric data are for time intervals larger than the processing time intervals, interpolation can be applied to generate higher resolution parameter values for the sets of upmix parameters. It will be appreciated that many different approaches for resampling (both to increase and decrease resolution) will be known to the person skilled in the art and that any suitable approach can be applied.

In some embodiments, the parameter generator 105 may advantageously comprise one or more artificial neural networks. In some embodiments, the parameter generator 105 may comprise a single artificial neural network which generates the sets of upmix parameter values for all subband artificial neural networks 107. However, in many embodiments, the parameter generator 105 may comprise an artificial neural network for a plurality of, and typically all, subband artificial neural networks 107. Thus, in some embodiments, the parameter generator 105 may include one artificial neural network for each subband artificial neural network 107.

The use of trained artificial neural network(s) to generate the sets of upmix parameters may provide an improved operation and performance in many scenarios, and in particular using subband artificial neural networks to generate the sets of upmix parameters may provide improved performance while maintaining low complexity and computational resource usage.

In some embodiments, the sets of upmix parameters may comprise the same number of parameters for each subband artificial neural network 107 and each subband artificial neural network 107 may comprise the same number of nodes receiving a contribution from an upmix parameter. For example, in some scenarios, each parameter set may comprise one set of complementary parameters that are included in the upmix parametric data for the subband of the subband artificial neural network 107. For example, a set of upmix parameters comprising IID, IPD and ICC parameter may be provided for each subband and subband artificial neural network 107. Thus, in such embodiments, each subband artificial neural network 107 may receive one IID, one IPD, and one ICC parameter which reflect the upmixing for that subband.

However, in other embodiments, the sets of upmix parameters have a different number of parameters for at least two subbands. For example, in some embodiments, for some subbands only one or two of the IID, IPD and ICC parameters may be included whereas for other subbands all of the parameters may be provided. This may for example reflect that some parameters are more relevant for some frequency ranges than others.

As another example, in some embodiments, some subbands may have different sizes and the upmix parametric data may comprise more upmix parameters for some subbands than others. The parameter generator 105 may for example generate more parameters for some subbands (e.g. for different frequency subranges within each subband) than for other subbands. The subband artificial neural networks 107 covering larger bandwidths and for which more upmix parameters are generated may accordingly be arranged to have more nodes receiving inputs from upmix parameters than other subband artificial neural networks 107.

As another example, in many embodiments, the update rate for upmix parameters may be different for different frequency ranges and therefore more parameter values may be present (or generated by the parameter generator 105) for some subbands than for others. For example, for some embodiments, one set of upmix parameters may be provided for some subbands whereas for other subbands multiple sets may be provided for different time instants withing the processing interval. The subband artificial neural networks 107 for these subbands may be arranged with different nodes for such parameter values being included in the determination of the subband samples of the multichannel audio signal.

Such approaches may typically allow improved multichannel audio signal reconstruction where processing can be adapted more accurately to different properties for different frequency ranges. In many embodiments, each subband may be processed by one subband artificial neural network 107 which generates all the subband samples for the multichannel audio signal. However, in some embodiments, one subband may include more than one subband artificial neural networks 107 generating subbands samples for different parts of the subband multichannel audio signal (as indeed one or more subbands may include no subband artificial neural networks).

For example, in some embodiments, the downmix audio signal subband samples and set of upmix parameter values for a given subband may be provided to two (or more) subband artificial neural networks 107 that generate subband samples for different parts of the subband of the multichannel audio signal.

The two subband artificial neural networks 107 for the given downmix audio signal subband may for example generate signals for different time intervals, e.g. one may generate subband samples for the first half of the processing time interval and the other may generate subband samples for the second half of the processing time interval.

In other embodiments, one subband artificial neural network 107 may for example generate subband samples for one sub-frequency range and the other may generate samples for another sub-frequency range of the subband. Such an approach may for example be particularly suitable for a scenario where the multichannel audio signal may comprise e.g. a specific tonal component at a particular frequency. One of the subband artificial neural networks 107 may be trained to accurately reflect such a tonal component when present, whereas the other subband artificial neural network 107 need not be compromised by being trained to generate subband samples that need not reflect such a tonal component. In such scenarios, the individual subband artificial neural networks may be trained to specifically provide output samples for the corresponding part of the generated subband signal. For example, a subband artificial neural network arranged to generate subband samples for the first half of a processing time interval will specifically be trained based on comparisons of generated samples to those of the first half of the original multichannel audio signal. Similarly, a subband artificial neural network 107 trained for a specific frequency interval of the subband will be trained based on the multichannel audio signal within that frequency interval.

The use of such multiple subband artificial neural networks 107 within each (downmix audio signal) subband may provide improved performance in many embodiments. It may often allow an improved multichannel audio signal to be generated that may closer correspond to the original multichannel audio signal. In particular, it may also in many embodiments allow a reduced complexity/computational resource despite using more subband artificial neural networks as these can typically each be of much lower complexity and have less computational requirements.

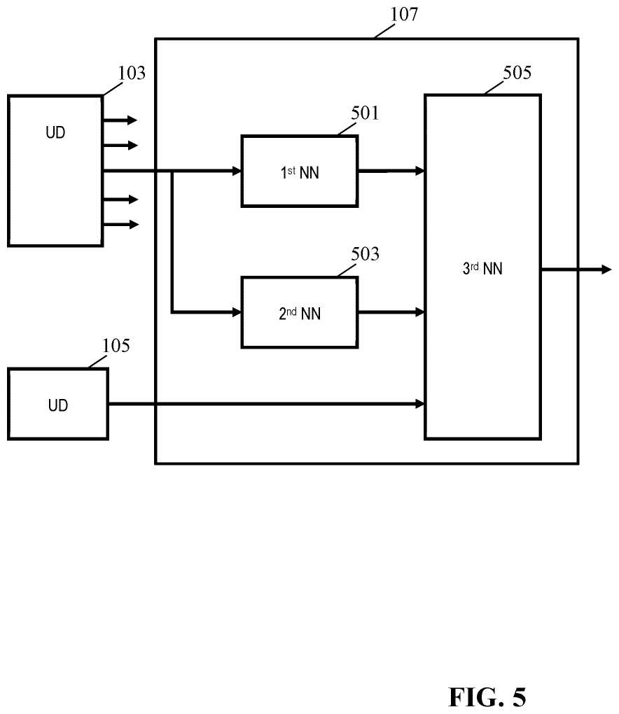

In some embodiments, one or more of the subband artificial neural networks 107 may be formed by including a plurality of subband artificial neural networks. In particular, as shown in FIG. 5, a subband artificial neural network 107 may be formed by three sub-artificial neural networks. In this case, the subband artificial neural network 107 comprises two sub-artificial neural networks 501, 503 that both receive the subband samples of the downmix audio signal (corresponding to the subband artificial neural network 107 having two input nodes for each subband sample). The output nodes of these two sub-artificial neural networks are also input nodes of a third sub-artificial neural network 505 which also has input nodes for receiving the sets of upmix parameters. The output nodes of this third sub-artificial neural network are the output nodes of the subband artificial neural network 107.

Such an arrangement has been found to be particularly efficient and provide a high quality reconstruction of the multichannel audio signal. The approach may further allow a sub-training where in particular the first and second sub-artificial neural networks 501, 503 may be individually and separately adapted to provide a desired result. This has been found to be particularly advantageous in many scenarios and for many signals.

In particular, the first sub-artificial neural network 501 may in some embodiments be trained to provide an e.g. mono-to-mono processing that provides a modified monosignal which is particularly suitable for upmixing. In addition, the second sub-artificial neural network 503 may be trained to provide a decorrelated or residual signal for the mono-to-mono downmix audio signal. The third sub-artificial neural network may be trained to provide a reconstructed multichannel audio signal. The third sub-artificial neural network may for example be trained by an end to end training that is based on comparing original multichannel audio signals to reconstructed multichannel audio signals based on the first and second sub-artificial neural networks 501, 503 having the configuration determined by a prior individual training.

In such an approach the first sub-artificial neural network may typically be relatively small as little temporal distortion is typically to be expected. The second sub-artificial neural network may be relatively larger, especially at low frequencies, as such an artificial neural network may better ensure proper decorrelation. The third sub-artificial neural network will tend to be relatively small. Overall, a reduced complexity and reduced computational resource can typically be achieved.

Artificial neural networks are adapted to specific purposes by a training process which are used to adapt/tune/modify the weights and other parameters (e.g. bias) of the artificial neural network. It will be appreciated that many different training processes and algorithms are known for training artificial neural networks. Typically, training is based on large training sets where a large number of examples of input data are provided to the network. Further, the output of the artificial neural network is typically (directly or indirectly) compared to an expected or ideal result. A cost function may be generated to reflect the desired outcome of the training process. In a typical scenario known as supervised learning, the cost function often represents the distance between the prediction and the ground truth for a particular input data. Based on the cost function, the weights may be changed and by reiterating the process for the modified weights, the artificial neural network may be adapted towards a state for which the cost function is minimized.

In more detail, during a training step the neural network may have two different flows of information from input to output (forward pass) and from output to input (backward pass). In the forward pass, the data is processed by the neural network as described above while in the backward pass the weights are updated to minimize the cost function. Typically, such a backward propagation follows the gradient direction of the cost function landscape. In other words, by comparing the predicted output with the ground truth for a batch of data input, one can estimate the direction in which the cost function is minimized and propagate backward, by updating the weights accordingly. Other approaches known for training artificial neural networks include for example Levenberg-Marquardt algorithm, the conjugate gradient method, and the Newton method etc.

In the present case, training may specifically include a training set comprising a potentially large number of multichannel audio signals. In some embodiments, training data may be multichannel audio signals in time segments corresponding to the processing time intervals of the artificial neural networks being trained, e.g. the number of samples in a training multichannel audio signal may correspond to a number of samples corresponding to the input nodes of the artificial neural network(s) being trained. Each training example may thus correspond to one operation of the artificial neural network(s) being trained. Usually, however, a batch of training samples is considered for each step to speed up the training process. Furthermore, many upgrades to gradient descent are possible also to speed up convergence or avoid local minima in the cost function landscape.

For each training multichannel audio signal, a training processor may perform a downmix operation to generate a downmix audio signal and corresponding upmix parametric data. Thus, the encoding process that is applied to the multichannel audio signal during normal operation may also be applied to the training multichannel audio signal thereby generating a downmix and the upmix parametric data.

In addition, the training processor may in some embodiments generate a residual signal which reflects the difference between the downmix audio signal and the multichannel audio signal, or more typically represents the part of the multichannel audio signal not properly represented by the downmix audio signal. For example, in many embodiments the training processor may generate a downmix signal and in addition may generate a residual signal which when used in an upmixing based on the upmix parametric data will result in a (more) accurate multichannel audio signal to be reconstructed. In addition, the training processor may generate upmix parameters.

Specifically, for a stereo multichannel audio signal, the training processor may use a Parametric Stereo scheme (e.g. in accordance with a suitable standardized approach). Such an encoding will apply a frequency- and time-dependent matrix operation, e.g. a rotation operation to the input stereo signal to generate a downmix signal and a residual signal. For example, typically a 2×2 matrix multiplication/complex value multiplication is applied to the input stereo signals to e.g. substantially align one of the rotated channel signals to have a maximum signal value. This channel may be used as the mono-signal and the rotation is typically performed on a frame basis. The rotation value may be stored as part of the upmix parametric data (or a parameter allowing this to be determined may be included in the upmix parametric data). Thus, in a synthesis apparatus, the opposite rotation may be performed to reconstruct the stereo signal. The rotation of the stereo signal results in another stereo signal of which one channel is accordingly aligned with the maximum intensity. The other channel is typically discarded in a Parametric Stereo encoder in order to reduce the data rate. In conventional Parametric Stereo decoding, a decorrelated signal is typically generated at the decoder and used for the upmixing process. In the current training approach this second signal may be used as a residual signal for the downmixing as it may represent the information discarded in the encoder, and thus it represents the ideal signal to be reconstructed in the decoder as part of an upmixing process.

Thus, in some embodiments, a training processor may from training multichannel audio signals generate training downmix signals and/or training residual signals and/or training upmix parameters.

Furthermore, the training processor may proceed to generate subbands for the generated downmix signals (and potentially for the residual signal if these are used). Similarly, for approaches where the parameter generator 105 processing is not based on an artificial neural network but is a predetermined operation (e.g. a selection or simple interpolation), the training processor may further proceed to generate sets of upmix parameters.

Thus, the training processor may generate sets of training data comprising subband downmix audio signals and subband sets of upmix parameters, and specifically it may include the same functionality as the encoder and decoder functions (including the functions of the receiver 101, the subband generator 103, and in some cases the parameter generator 105) that results in the samples and sets of upmix parameters that would be generated by the audio apparatus and provided to the subband artificial neural networks 107. Based on these input values, the subband artificial neural networks 107 may then proceed to generate subband samples for the multichannel audio signal. These may be converted to the time domain to result in a reconstructed multichannel audio signal. This reconstructed multichannel audio signal may then be compared to the original training multichannel audio signal as part of a cost function which may then be used to adapt the subband artificial neural networks 107. The training may accordingly be a subband training where subband data is generated and applied to the individual subband artificial neural networks 107 and with the output of the subband artificial neural networks 107 being combined into a multichannel audio signal that can be evaluated by a cost function.

In cases where the parameter generator 105 also includes one or more artificial neural networks, the generated upmix parametric data may also be applied to the parameter generator 105 with this generating the sets of upmix parameters based on a current configuration. In this case, the training, and specifically updating, may include the artificial neural network(s) of the parameter generator 105 as well as the subband artificial neural networks.

Further, in some embodiments, the cost function may include a contribution that reflects how closely the upmix parameters generated by artificial neural network(s) of the parameter generator 105 correspond to the original training parameters generated by the training processor. In some embodiments, the parameter generator 105 may be trained separately from the subband artificial neural networks 107 and a cost function may be used based solely on comparing the generated parameter values to the input training upmix parametric data.

However, in many embodiments, the artificial neural network(s) of the parameter generator 105 may be jointly trained with the subband artificial neural networks 107 and the cost function may in many cases include both a contribution indicative of the difference between the input training multichannel audio signals and the reconstructed multichannel audio signals as well as a contribution indicative of the difference between the upmix parameters for the input training multichannel audio signals and upmix parameters generated by the artificial neural network(s) of the parameter generator 105.

In embodiments where one or more of the subband artificial neural networks 107 are divided into sub-artificial neural networks, as e.g. in the example of FIG. 5, the training of the first and/or second sub-artificial neural networks 501, 503 may be trained separately and prior to the training of the third sub-artificial neural network 505. For example, the first sub-artificial neural network 501 may be trained using the generated training downmix audio signals and comparing the resulting downmix audio signal to this.

Similarly, the second sub-artificial neural network 503 may be trained based on being fed subband samples of the training downmix audio signals and a cost function based on a comparison of the resulting output to the generated training residual signals.

A training approach may be used where an output from the neural network operation is determined from training signals and a cost function is applied to determine a cost value for each training signal and/or for the combined set of signals (e.g. an average cost value for the training sets is determined). The cost function may include various components.

Typically, the cost function will include at least one component that reflects how close a generated signal is to a reference signal, i.e. a so-called reconstruction error. In some embodiments the cost function will include at least one component that reflects how close a generated signal is to a reference signal from a perceptual point of view.

For example, in some embodiments, the multichannel audio signal generated by the subband artificial neural network (and optionally any artificial neural network of the parameter generator 105) for a given training multichannel audio signal may be compared to the original training multichannel audio signal. A cost function contribution may be generated that reflects the difference between these. This process may be generated for all training sets to generate an overall cost function. Further, the approach may be applied separately or jointly in each subband. In that case, the cost function may represent the difference between subbands of the reconstructed multichannel audio signal and subbands of the original multichannel audio signal. For example, using independent subband artificial neural networks, and assuming one does not take into account perception, training of individual subband artificial neural networks, e.g. using an RMSE type of cost function per subband, is feasible.

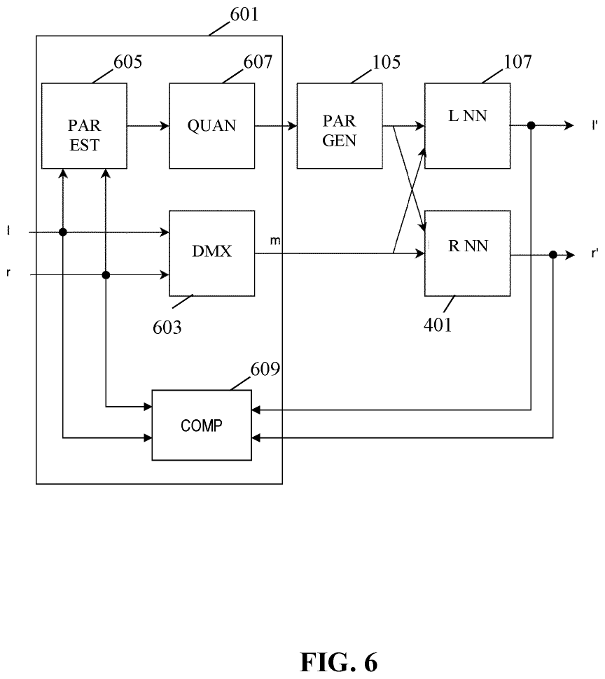

Such an example is illustrated in FIG. 6 for a stereo multichannel audio signal. The example of FIG. 6 is of a training setup that specifically trains a left channel subband artificial neural network 107 and a right channel subband artificial neural network 401 (and in some cases one or more artificial neural networks comprised in the parameter generator 105 may also be jointly trained with the subband artificial neural networks using such a training setup). It will be appreciated that in scenarios where other artificial neural networks may be present, e.g., if used in an encoder to generate the upmix parametric data (e.g. as a latent representation of the downmix audio signal), such artificial neural networks may be added to the shown training setup for a joint training.

In the example, a training processor 601 may receive training multichannel audio signals, which in the specific example are stereo signals. In the example, the multichannel audio signal may be received as a subband signal, and the following description will focus on the implementation in a single subband. The same approach may be reused for other subbands.

For a given training signal, a downmixer 603 performs a downmixing operation to generate a training downmix audio signal, which in the specific example is a training mono audio signal. The downmix audio signal is input to the subband artificial neural networks 107.

In addition, the multichannel audio signal is fed to a parameter estimator 605 which proceeds to generate upmix parameters as would be done in an encoder. In the example, the upmix parameters are typically e.g., IID/IPD/ICC parameters that are generated by an analytical function being applied to the input training multichannel audio signal, and specifically the parameters are generated as they would be in an encoder (e.g., a legacy encoder). The parameters are optionally quantized and encoded/decoded in an emulator 607 to generate upmix parameters as they would be when input to the parameter generator 105.

The parameter generator 105 and the subband artificial neural networks 107, 401 may then proceed to reconstruct the stereo multichannel audio signal l′, r′.

The reconstructed signals l′, r′ are fed to a comparator 609 which proceeds to generate a cost value based on a cost function which may include a contribution indicative of the difference between the original and the reconstructed signals. In many embodiments, the cost function may include a contribution reflecting how closely the upmix parameters generated by the parameter generator 105 match the upmix parameters generated by the parameter estimator.

It will be appreciated that many different approaches may be used to determine the cost value reflecting difference between the signals. For example, a correlation may be performed with the cost value having a monotonically decreasing value for the increasing correlation value. As another example, the two signals may be subtracted from each other and a power measure for the difference signal may be used as a cost value. It will be appreciated that many other approaches are available and may be used.

As a specific example, a training procedure may be applied which has the goal of minimizing the distance l-l′, and r-r′ and re-instate the upmix parameters (e.g. IID/IPD/ICC) as closely as possible. For a given frame (1, r) the (legacy) upmix parameters IID (level difference between left and right per frequency band), ICC (correlation between left and right per frequency band) and IPD (phase difference between left and right) can be determined, next to an energy-preserving downmix m. Then the (optional) artificial neural network of the parameter generator 105 and the left and right subband artificial neural network 107 can be trained jointly to minimize a reconstruction error l-l′ and r-r′ balanced with the reinstatement of the upmix parameters. This means that the loss function will be a combination of signal reconstruction error in combination with PS parameter reinstatement. In particular:

Loss=d_{reconstruction}+α·dₛₜₑᵣₑₒ
with α being a parameter to tune the balance between signal reconstruction and stereo image reconstruction, and where:

$${d}_{reconstruction} = {‖ l - {l}^{′} ‖}_{2}^{2} + {‖ r - {r}^{′} ‖}_{2}^{2}$$

$$and :$$

$${d}_{stereo} = {‖ ii d ( l , r ) - i id ( {l}^{′} , {r}^{′} ) ‖}_{2}^{2} + {‖ ic c ( l , r ) - i cc ( {l}^{′} , {r}^{′} ) ‖}_{2}^{2}$$

where iid(l, r) represents the intensity difference between left and right, possibly in the log domain for perceptual matching and icc(l, r) represents the complex-valued (to include phase information) correlation between left and right signals, possibly in the normalized domain for perceptual matching. Since the signal reconstruction error will already ensure that the IID is roughly reinstated, the first part of the stereo image loss might be discarded.

Thus, in the example, the cost function generates a cost value that reflects how closely the generated multichannel audio signals match the corresponding training multichannel audio signals.

Based on the cost value, the training processor 601 may adapt the weights of the artificial neural networks. For example, a back-propagation approach may be used. In particular, the training processor 601 may adjust the weights of both the subband artificial neural network 107 and the artificial neural network of the parameter generator 105 based on the cost value. For example, given the derivative (representing the slope) of the weights with respect to the cost function the weights values are modified to go in the opposite direction of the slope. For a simple/minima account one can refer to the training of the perceptron (single neuron) in case of backward pass of a single data input.

The process may be iterated until the artificial neural networks are considered to be trained. For example, training may be performed for a predetermined number of iterations. As another example, training may be continued until the weights change be less than a predetermined amount. Also very common, a validation stop is implemented where the network is tested again a validation metric and stopped when reaching the expected outcome.

The artificial neural networks may be (further) trained using training data that does not directly represent audio sources/signals, but which convey relevant and similar meaningful information. A particular example is to include text based training data. Training the artificial neural networks based on text may allow the networks to further improve their understanding of language, and therefore improve audio reconstruction. For example, by coupling text and audio, predicting a sequence of words would be easier than simply using one modality. The same applies to a stream of video plus audio (e.g., in the example of lips syncing or reading).

The audio apparatus(s) may specifically be implemented in one or more suitably programmed processors. In particular, the artificial neural networks may be implemented in one more such suitably programmed processors. The different functional blocks, and in particular the artificial neural networks, may be implemented in separate processors and/or may e.g. be implemented in the same processor. An example of a suitable processor is provided in the following.

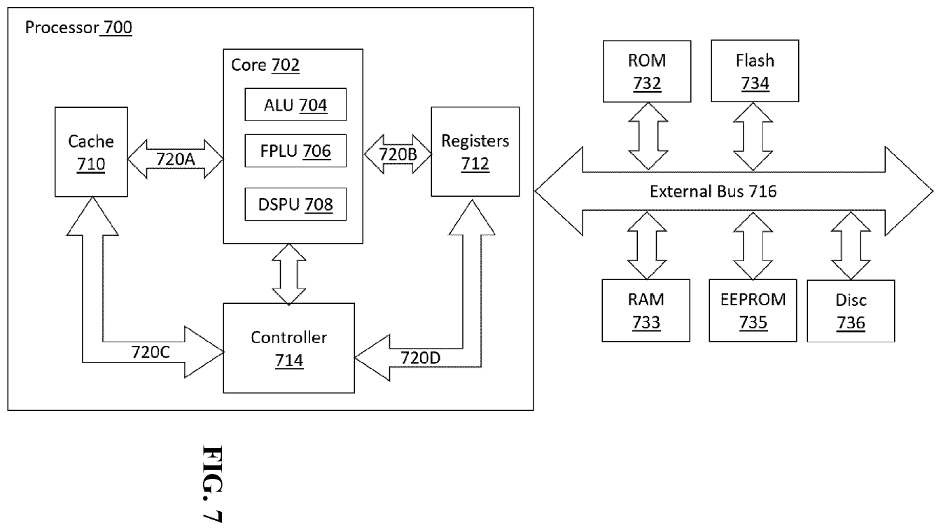

FIG. 7 is a block diagram illustrating an example processor 700 according to embodiments of the disclosure. Processor 700 may be used to implement one or more processors implementing an apparatus as previously described or elements thereof (including in particular one more artificial neural network). Processor 700 may be any suitable processor type including, but not limited to, a microprocessor, a microcontroller, a Digital Signal Processor (DSP), a Field ProGrammable Array (FPGA) where the FPGA has been programmed to form a processor, a Graphical Processing Unit (GPU), an Application Specific Integrated Circuit (ASIC) where the ASIC has been designed to form a processor, or a combination thereof.

The processor 700 may include one or more cores 702. The core 702 may include one or more Arithmetic Logic Units (ALU) 704. In some embodiments, the core 702 may include a Floating Point Logic Unit (FPLU) 706 and/or a Digital Signal Processing Unit (DSPU) 708 in addition to or instead of the ALU 704.

The processor 700 may include one or more registers 712 communicatively coupled to the core 702. The registers 712 may be implemented using dedicated logic gate circuits (e.g., flip-flops) and/or any memory technology. In some embodiments the registers 712 may be implemented using static memory. The register may provide data, instructions and addresses to the core 702.

In some embodiments, processor 700 may include one or more levels of cache memory 710 communicatively coupled to the core 702. The cache memory 710 may provide computer-readable instructions to the core 702 for execution. The cache memory 710 may provide data for processing by the core 702. In some embodiments, the computer-readable instructions may have been provided to the cache memory 710 by a local memory, for example, local memory attached to the external bus 716. The cache memory 710 may be implemented with any suitable cache memory type, for example, Metal-Oxide Semiconductor (MOS) memory such as Static Random Access Memory (SRAM), Dynamic Random Access Memory (DRAM), and/or any other suitable memory technology.

The processor 700 may include a controller 714, which may control input to the processor 700 from other processors and/or components included in a system and/or outputs from the processor 700 to other processors and/or components included in the system. Controller 714 may control the data paths in the ALU 704, FPLU 706 and/or DSPU 708. Controller 714 may be implemented as one or more state machines, data paths and/or dedicated control logic. The gates of controller 714 may be implemented as standalone gates, FPGA, ASIC or any other suitable technology.

The registers 712 and the cache 710 may communicate with controller 714 and core 702 via internal connections 720A, 720B, 720C and 720D. Internal connections may be implemented as a bus, multiplexer, crossbar switch, and/or any other suitable connection technology.

Inputs and outputs for the processor 700 may be provided via a bus 716, which may include one or more conductive lines. The bus 716 may be communicatively coupled to one or more components of processor 700, for example the controller 714, cache 710, and/or register 712. The bus 716 may be coupled to one or more components of the system.

The bus 716 may be coupled to one or more external memories. The external memories may include Read Only Memory (ROM) 732. ROM 732 may be a masked ROM, Electronically Programmable Read Only Memory (EPROM) or any other suitable technology. The external memory may include Random Access Memory (RAM) 733. RAM 733 may be a static RAM, battery backed up static RAM, Dynamic RAM (DRAM) or any other suitable technology. The external memory may include Electrically Erasable Programmable Read Only Memory (EEPROM) 735. The external memory may include Flash memory 734. The External memory may include a magnetic storage device such as disc 736. In some embodiments, the external memories may be included in a system.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units, circuits and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements, circuits or method steps may be implemented by e.g. a single circuit, unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc. do not preclude a plurality. Reference signs in the claims are provided merely as a clarifying example shall not be construed as limiting the scope of the claims in any way.

1. An apparatus comprising:
a receiver circuit, wherein the receiver circuit is arranged to receive an audio data signal comprising:
a downmix audio signal for a multichannel audio signal; and
upmix parametric data for upmixing the downmix audio signal;
a subband generator circuit, wherein the subband generator circuit is arranged to generate a plurality of frequency subband signals for subbands of the downmix audio signal;
an artificial neural network,
wherein the artificial neural network comprises a plurality of subband artificial neural networks,
wherein each subband artificial neural network of the plurality of subband artificial neural networks is arranged to generate subband samples for a subband of a frequency subband representation of the multichannel audio signal,
a parameter generator circuit, wherein the parameter generator circuit is arranged to generate pluralities of upmix parameter values for subbands of the frequency subband representation of the multichannel audio signal from the upmix parametric data; and
a generator circuit, wherein the generator circuit is arranged to generate the multichannel audio signal from the subband samples of the subbands of the multichannel audio signal,
wherein each subband artificial neural network comprises a plurality of nodes arranged to receive a plurality of upmix parameter values and samples of at least one frequency subband signal of the plurality of frequency subband signals,
wherein the at least one frequency subband signal is for a subband for which the subband artificial neural network generates subband samples of the multichannel audio signal.

2. The audio apparatus of claim 1, wherein at least a first subband artificial neural network of the plurality of subband artificial neural networks comprises nodes for receiving parameter values of pluralities of upmix parameter values for other subbands than the subband of the subband artificial neural network.

3. The audio apparatus of claim 1, wherein at least a portion of parameters of the pluralities of upmix parameter values for different subband artificial neural networks are the same.

4. The audio apparatus of claim 1, wherein at least a portion of parameters of the pluralities of upmix parameter values for different subband artificial neural networks are different.

5. The audio apparatus of claim 1, wherein the plurality of subband artificial neural networks for at least one subband comprises separate artificial neural networks for different channels of the multichannel audio signal.

6. The audio apparatus of claim 1,
wherein the parameter generator circuit is arranged to change a resolution of the pluralities of upmix parameter values relative to a resolution of the upmix parametric data to match a resolution of a processing of the plurality of subband artificial neural networks,
wherein the resolution of the processing of the plurality of subband artificial neural networks is one of a frequency resolution of the subbands and a time resolution for a processing time interval for the plurality of subband networks.

7. The audio apparatus of claim 6,
wherein the parameter generator circuit comprises at least one artificial neural network,
wherein the at least one artificial neural network has input nodes and output nodes,
wherein the input nodes receive parameter values of the upmix parametric data,
wherein the output nodes provide a plurality of upmix parameter values for a first subband artificial neural network of the plurality of subband artificial neural networks.

8. The audio apparatus of claim 1,
wherein at least one first subband of the plurality of subband artificial neural networks comprise at least two subband artificial neural networks,
wherein the at least two subband artificial neural networks are arranged to generate samples for different components of a subband signal for the first subband.

9. The audio apparatus of claim 1,
wherein the plurality of subband artificial neural networks are trained by training data,
wherein the training data comprises training input audio signals,
wherein the training input audio signals comprise samples of input multichannel audio signals,
wherein the plurality of subband artificial neural networks are trained by using a cost function,
wherein the cost function comprises a component indicative of a difference between the training input audio signals and multichannel audio signals generated by the plurality of subband artificial neural networks.

10. The audio apparatus of claim 1,
wherein the plurality of subband artificial neural networks are trained by training data,
wherein the training data comprises training input audio signals,
wherein the training input audio signals comprises samples of input multichannel audio signals,
wherein the plurality of subband artificial neural networks are trained by using a cost function
wherein the cost function comprises a component indicative of a difference between upmix parameter values for the input audio signals and upmix parameter values for the multichannel audio signals generated by the plurality of subband artificial neural networks.

11. The audio apparatus of claim 1, wherein at least one subband artificial neural network of the plurality of subband artificial neural networks comprises:
a first sub-artificial neural network,
wherein the first sub-artificial neural network has first input nodes and first output nodes,
wherein the first input nodes are arranged to receive samples of frequency subband signals for the subband of the subband artificial neural network,
wherein the first output nodes are arranged to provide samples of a modified downmix audio signal;
a second sub-artificial neural network,
wherein the second sub-artificial neural network has second input nodes and second output nodes,
wherein the second input nodes are arranged to receive samples of frequency subband signals for the subband of the subband artificial neural network,
wherein the second output nodes are arranged to provide samples of an auxiliary audio signal;
a third sub-artificial neural network,
wherein the third sub-artificial neural network has third input nodes, forth input nodes and fifth input nodes,
wherein the third input nodes are arranged to receive samples of the modified downmix audio signal,
wherein the fourth input nodes are arranged to receive samples of an auxiliary audio signal,
wherein the fifth input nodes are arranged to receive a plurality of upmix parameter values for the subband of the subband artificial neural network,
wherein the third sub-artificial neural network is arranged to generate the subband samples for the subband of the frequency subband representation of the multichannel audio signal.

12. The audio apparatus of claim 1, wherein the pluralities of upmix parameter values have a different number of parameters for at least two subbands.

13. The audio apparatus of claim 1,
wherein the upmix parametric data provides parametric data for sequential time intervals,
wherein at least a first subband artificial neural network of the plurality of subband artificial neural networks comprises first nodes,
wherein the first nodes are arranged to receive parameter values of a plurality of upmix parameter values for another time interval of the sequential time interval than a time interval for which subband samples of the multichannel audio signal are generated.

14. The apparatus of claim 1, wherein the plurality of subband artificial neural networks are arranged to receive only subband samples of the downmix audio signal and parameter values generated from the upmix parametric data.

15. A method comprising:
receiving an audio data signal, the audio data signal comprising:
a downmix audio signal for a multichannel audio signal; and
upmix parametric data for upmixing the downmix audio signal;
generating a plurality of frequency subband signals for subbands of the downmix audio signal wherein each subband artificial neural network of a plurality of subband artificial neural networks is arranged to generate subband samples for a subband of a frequency subband representation of the multichannel audio signal;
generating pluralities of upmix parameter values for subbands of the frequency subband representation of the multichannel audio signal from the upmix parametric data; and
generating the multichannel audio signal from the subband samples of the subbands of the multichannel audio signal,
wherein each subband artificial neural network comprises a plurality of nodes receiving a plurality of upmix parameter values and samples of at least one frequency subband signal of the plurality of frequency subband signals,
wherein the at least one frequency subband signal is for a subband for which the subband artificial neural network generates subband samples of the multichannel audio signal.

16. A computer program stored on a non-transitory medium, wherein the computer program when executed on a processor performs the method as claimed in claim 14.

17. The method of claim 15, wherein at least a first subband artificial neural network of the plurality of subband artificial neural networks comprises nodes for receiving parameter values of the pluralities of upmix parameter values for other subbands than the subband of the subband artificial neural network.

18. The method of claim 15, wherein at least a portion of parameters of the pluralities of upmix parameter values for different subband artificial neural networks are the same.

19. The method of claim 15, wherein at least a portion of parameters of the pluralities of upmix parameter values for different subband artificial neural networks are different.

20. The method of claim 15, wherein the plurality of subband artificial neural networks for at least one subband comprises separate artificial neural networks for different channels of the multichannel audio signal.

21. The method of claim 15, further comprising changing a resolution of the pluralities of upmix parameter values relative to a resolution of the upmix parametric data to match a resolution of a processing of the plurality of subband artificial neural networks, wherein the resolution of the processing of the plurality of subband artificial neural networks is one of a frequency resolution of the subbands and a time resolution for a processing time interval for the plurality of subband networks.

22. The method of claim 21,
wherein the at least one artificial neural network has input nodes and output nodes,
wherein the input nodes receive parameter values of the upmix parametric data,
wherein the output nodes provide a plurality of upmix parameter values for a first subband artificial neural network of the plurality of subband artificial neural networks.

23. The method of claim 15,
wherein at least one first subband of the plurality of subband artificial neural networks comprise at least two subband artificial neural networks,
wherein the at least two subband artificial neural networks are arranged to generate samples for different components of a subband signal for the first subband.

24. The method of claim 15,
wherein the plurality of subband artificial neural networks are trained by training data,
wherein the training data comprises training input audio signals,
wherein the training input audio signals comprise samples of input multichannel audio signals,
wherein the plurality of subband artificial neural networks are trained by using a cost function,
wherein the cost function comprises a component indicative of a difference between the training input audio signals and multichannel audio signals generated by the plurality of subband artificial neural networks.

25. The method of claim 15,
wherein the plurality of subband artificial neural networks are trained by training data,
wherein the training data comprises training input audio signals,
wherein the training input audio signals comprises samples of input multichannel audio signals,
wherein the plurality of subband artificial neural networks are trained by using a cost function
wherein the cost function comprises a component indicative of a difference between upmix parameter values for the input audio signals and upmix parameter values for the multichannel audio signals generated by the plurality of subband artificial neural networks.

26. The method of claim 15, wherein at least one subband artificial neural network of the plurality of subband artificial neural networks comprises:
a first sub-artificial neural network,
wherein the first sub-artificial neural network has first input nodes and first output nodes,
wherein the first input nodes are arranged to receive samples of frequency subband signals for the subband of the subband artificial neural network,
wherein the first output nodes are arranged to provide samples of a modified downmix audio signal;
a second sub-artificial neural network,
wherein the second sub-artificial neural network has second input nodes and second output nodes,
wherein the second input nodes are arranged to receive samples of frequency subband signals for the subband of the subband artificial neural network,
wherein the second output nodes are arranged to provide samples of an auxiliary audio signal;
a third sub-artificial neural network,
wherein the third sub-artificial neural network has third input nodes, forth input nodes and fifth input nodes,
wherein the third input nodes are arranged to receive samples of the modified downmix audio signal,
wherein the fourth input nodes are arranged to receive samples of an auxiliary audio signal,
wherein the fifth input nodes are arranged to receive nodes receiving a plurality of upmix parameter values for the subband of the subband artificial neural network,
wherein the third sub-artificial neural network is arranged to generate the subband samples for the subband of the frequency subband representation of the multichannel audio signal.

27. The method of claim 15, wherein the pluralities of upmix parameter values have a different number of parameters for at least two subbands.

28. The method of claim 15,
wherein the upmix parametric data provides parametric data for sequential time intervals,
wherein at least a first subband artificial neural network of the plurality of subband artificial neural networks comprises first nodes,
wherein the first nodes are arranged to receive parameter values of a plurality of upmix parameter values for another time interval of the sequential time interval than a time interval for which subband samples of the multichannel audio signal are generated.

29. The method of claim 15, wherein the plurality of subband artificial neural networks are arranged to receive only subband samples of the downmix audio signal and parameter values generated from the upmix parametric data.
